(19) United States
(12) Patent Application Publication
(10) Pub. No.: US 2025/0366679 A1
(43) Pub. Date: Dec. 4, 2025

(54) CLEANING ASSEMBLY

(71) Applicant: Quanzhou Komoo Intelligent Kitchen & Bath Co., Ltd, Quanzhou (CN)

(72) Inventors: Xiaofa LIN, Quanzhou (CN); Xiaoshan LIN, Quanzhou (CN); Zuhua LIU, Quanzhou (CN); Shan LIN, Quanzhou (CN); Yaxin Xu, Quanzhou (CN)

(21) Appl. No.: 19/299,578

(22) Filed: Aug. 14, 2025

Related U.S. Application Data
(63) Continuation of application No. PCT/CN2024/074736, filed on Jan. 30, 2024.

(30) Foreign Application Priority Data
Feb. 14, 2023 (CN) 202310115559.8

(51) Int. Cl. A47K 13/30

(52) U.S. Cl. CPC A47K 13/302

(57) ABSTRACT

A cleaning assembly, which includes a bracket and a spray bar portion, a front end of the spray bar portion is disposed with a self-cleaning assembly, the self-cleaning assembly includes an upper cover and a pressure plate, the upper cover includes cleaning holes, the pressure plate is pivotally connected to the upper cover, a reset device is disposed between the pressure plate and the upper cover, descaling pieces are further disposed on the pressure plate, and a position-limiting portion is disposed on the bracket; and when the spray bar portion extends and retracts, the pressure plate abuts the position-limiting portion, causing the pressure plate to swing upward around a hinged position with the upper cover, thus inserting the descaling pieces into the cleaning holes, after the pressure plate is separated from the position-limiting portion, and the reset device pulls the descaling pieces out of the cleaning holes.

### RELATED APPLICATIONS

This application is a continuation of International patent application PCT/CN2024/074736, filed on Jan. 30, 2024, which claims priority to Chinese patent application 202310115559.8, filed on Feb. 14, 2023. International patent application PCT/CN2024/074736 and Chinese patent application 202310115559.8 are incorporated herein by reference.

### FIELD OF THE DISCLOSURE

The present disclosure relates to the technical field in self-cleaning nozzles, and in particular relates to a cleaning assembly for a toilet.

### BACKGROUND OF THE DISCLOSURE

At present, smart toilets and toilet seat covers have become one of the key hardware to take into account in bathroom decoration. However, there are huge differences in water quality across various regions in China, and scale deposition due to water quality issues often occur, especially in hard water regions, eventually leading to a failure of a water outflow pipeline in the smart toilet seat covers. This poses a huge challenge to the use of the smart toilets.

Therefore, a self-cleaning function is used as one of the core functions of the smart toilet seats for various enterprises for researching and developing bathroom fixtures. Water is heated after entering a water passage system in the smart toilet seat covers and then sprayed out from cleaning holes on a front end, thus achieving the self-cleaning function of nozzles. However, water in the hard water regions contains a large amount of calcium and magnesium ions, which easily form scale after heating. As the scale is continually forming during the use of the smart toilets, blockage of the cleaning holes is easily caused, resulting in a failure of the self-cleaning function of the smart toilet seat covers. Therefore, how to effectively and promptly dredge and clean the cleaning holes is one of the pain points in the industry.

Chinese patent application 201921610541.0 discloses a self-cleaning flushing device for a human body. During an extension-retraction process, a self-cleaning water passage sprays water to the nozzles, and cleaning elements and the nozzles rub each other to clean the nozzles. However, this patent application can only be used to clean outer surfaces of the nozzles and cannot remove scale from deep inside of the nozzles.

### BRIEF SUMMARY OF THE DISCLOSURE

An objective of the present disclosure is to provide a cleaning assembly to solve the deficiencies in the existing techniques.

In order to achieve the aforementioned objective, the technical solution of the present disclosure is as follows.

A cleaning assembly, comprising a bracket, and a spray bar portion configured to extend and retract on the bracket, a self-cleaning assembly configured to extend and retract with the spray bar portion is disposed on a front end of the spray bar portion, the self-cleaning assembly comprises an upper cover and a pressure plate, the upper cover comprises one or more cleaning holes and a slot, a first end of the pressure plate is pivotally connected to an inner side of the slot and is located on an outer side of the upper cover, an actuating portion is disposed on a second end of the pressure plate, a reset device is disposed between the pressure plate and the upper cover, one or more descaling pieces are further disposed on the pressure plate, a position-limiting portion configured to abut the actuating portion is disposed on the bracket, the position-limiting portion is located on a path along which the self-cleaning assembly extends and retracts with the spray bar portion, when the spray bar portion drives the self-cleaning assembly to extend and retract, the actuating portion of the pressure plate abuts the position-limiting portion, causing the pressure plate to swing around the slot in a direction towards the upper cover, thus inserting the one or more descaling pieces into the one or more cleaning holes, and when the spray bar portion drives the self-cleaning assembly to continuously extend and retract, the actuating portion is separated from the position-limiting portion, and the reset device pulls the one or more descaling pieces out of the one or more cleaning holes completely.

Further, the pressure plate is pivotally connected to a bottom of the upper cover through the slot, and the actuating portion is disposed on a lower end surface of the pressure plate, so that the pressure plate is configured to abut the position-limiting portion when the pressure plate extends and retracts with the spray bar portion, thereby pushing the pressure plate to enable the second end of the pressure plate to swing about the slot in the direction towards the upper cover.

Further, driving surfaces are disposed on front and rear sides of the actuating portion along an extension-retraction direction of the pressure plate, and heights of the driving surfaces are higher than that of the position-limiting portion.

Further, the driving surfaces comprise a first driving surface and a second driving surface, a transition portion is connected to the first driving surface and the second driving surface, when the spray bar portion extends, the position-limiting portion abuts and pushes the first driving surface to allow the pressure plate to swing upward, when the spray bar portion retracts, the position-limiting portion abuts and pushes the second driving surface to allow the pressure plate to swing upward, and when the transition portion abuts the position-limiting portion, the pressure plate swings upward to a highest point.

Further, a guide portion is disposed on a front end of the bracket, the guide portion comprises a guide hole configured to allow the spray bar portion to extend and retract, and at least part of an inner wall surface of a bottom of the guide hole constitutes the position-limiting portion.

Further, the pressure plate comprises one or more first installation positions and a second installation position, the one or more first installation positions are away from the first end of the pressure plate pivotally connected to the slot and are used for installing the one or more descaling pieces, and the second installation position is adjacent to the first end of the pressure plate pivotally connected to the slot, and is used for installing the reset device.

Further, one or more sealing pieces are buckled into the one or more first installation positions, and the one or more sealing pieces are sleeved on one or more lower portions of the one or more descaling pieces.

Further, a lower end of the upper cover is connected to a lower cover, the lower cover comprises one or more through holes and an accommodating groove, the one or more sealing pieces slidably and hermetically cooperate with one or more inner sides of the one or more through holes, and the accommodating groove cooperates with the second installation position to fix an upper end and a lower end of the reset device respectively.

Further, one or more parts of the one or more sealing pieces disposed in the one or more through holes are Y-shaped.

Further, a front end of the lower cover comprises a fixing portion, the first end of the pressure plate comprises a first buckle, the second end of the pressure plate comprises a second buckle, the second installation position is adjacent to the first buckle, the actuating portion and the one or more first installation positions are adjacent to the second buckle, the first buckle is pivotally connected to the slot, and the second buckle is overlapped with the fixing portion.

Further, the fixing portion comprises two buckles with opposite hooks, and the second buckle comprises a fixing surface overlapped with the opposite hooks.

Further, an upper end of the upper cover comprises a third installation position for installing a nozzle cover, and the nozzle cover comprises nozzles in communication with the one or more cleaning holes.

The present disclosure has the following advantages.
1. In the cleaning assembly proposed by the present disclosure, the self-cleaning assembly is disposed on the front end of the spray bar portion and extends and retracts with the spray bar portion to move forward and backward. The position-limiting portion is disposed on the path along which the self-cleaning assembly extends and retracts. During a movement process, the actuating portion of the pressure plate can abut the position-limiting portion, causing the pressure plate to swing around the first end of the pressure plate pivotally connected to the upper cover, thus inserting the one or more descaling pieces on the pressure plate into the one or more cleaning holes. When the actuating portion of the pressure plate is separated from the position-limiting portion, the reset device pulls the one or more descaling pieces out of the one or more cleaning holes completely. The actuating portion of the pressure plate respectively abuts the position-limiting portion during an extension-retraction process, so that the position-limiting portion respectively pushes the pressure plate to swing in the direction towards the upper cover during the extension-retraction process of the pressure plate, thus respectively inserting the one or more descaling pieces into the one or more cleaning holes during the extension-retraction process. Therefore, the one or more descaling pieces can clean the one or more cleaning holes twice in a single extension-retraction cycle of the spray bar portion, effectively preventing scaling in the one or more cleaning holes.
2. In the cleaning assembly proposed by the present disclosure, the actuating portion is disposed on the bottom of the front end of the pressure plate, and the driving surfaces are disposed on the front and rear sides of the actuating portion along the extension-retraction direction of the pressure plate. The driving surfaces are higher than the position-limiting portion, facilitating the position-limiting portion to push the pressure plate to swing through the driving surfaces. Since the driving surfaces are disposed on both of the front and rear sides of the actuating portion along the extension-retraction direction of the pressure plate, the position-limiting portion respectively pushes the pressure plate to allow the one or more descaling pieces to be inserted into the one or more cleaning holes during the extension-retraction process of the spray bar portion. Therefore, the one or more cleaning holes are dredged and cleaned before and after every time the spray bar portion is used.
3. In the cleaning assembly proposed by the present disclosure, the driving surfaces comprise the first driving surface and the second driving surface, and the transition portion is connected to the first driving surface and the second driving surface. When of the spray bar portion extends, the position-limiting portion pushes the pressure plate to swing upward through the first driving surface. When the spray bar portion retracts, the position-limiting portion pushes the pressure plate to swing upward through the second driving surface. When the transition portion abuts the position-limiting portion, the pressure plate swings upward to the highest point.
4. In the cleaning assembly proposed by the present disclosure, the reset device is disposed between the pressure plate and the lower cover to ensure that the one or more descaling pieces can return to the initial position after being inserted into the one or more cleaning holes for dredging and cleaning, and the second installation position of the pressure plate and the accommodating groove of the lower cover fix the lower end and the upper end of the reset device respectively to ensure that the position of the reset device does not dislocate during the operation process.
5. In the cleaning assembly proposed by the present disclosure, one or more sealing pieces are sleeved outside of the one or more descaling pieces, and the one or more sealing pieces are buckled on the pressure plate. The one or more sealing pieces slidably and hermetically cooperate with the one or more inner sides of the one or more through holes of the lower cover, and the one or more parts of the one or more sealing pieces located in the one or more through holes are Y-shaped, thus reducing frictional resistance forces of the one or more sealing pieces with the one or more inner walls of the one or more through holes during the sliding process while ensuring sealing.
6. In the cleaning assembly proposed by the present disclosure, the first end of the pressure plate comprises the first buckle, and the second end of the pressure plate comprises the second buckle. The first buckle is pivotally connected to an inner side of the slot, allowing the pressure plate to swing around the slot. The lower end of the lower cover comprises the fixing portion configured to allow the second buckle to be overlapped, and the fixing portion is used to limit the initial position of the pressure plate.
7. The cleaning assembly, which comprises the bracket and the spray bar portion configured to extend and retract on the bracket, the front end of the spray bar portion is disposed with the self-cleaning assembly, the self-cleaning assembly comprises the upper cover and the pressure plate, the upper cover comprises the one or more cleaning holes, the one end of the pressure plate is pivotally connected to the lower side of the upper cover, the reset device is disposed between the pressure plate and the upper cover, the one or more descaling pieces are further disposed on the pressure plate, and the position-limiting portion is disposed on the bracket; and when the spray bar portion extends and retracts, the pressure plate abuts the position-limiting portion, causing the pressure plate to swing upward around a hinged position with the upper cover, thus inserting the one or more descaling pieces into the one or more cleaning holes, after the pressure plate is separated from the position-limiting portion, and the reset device pulls the one or more descaling pieces out of the one or more cleaning holes.

### BRIEF DESCRIPTION OF THE DRAWING

In order to more clearly illustrate the technical solutions in the embodiments of the present disclosure or in the existing techniques, the accompanying drawings used in the description of the embodiments or the existing techniques will be briefly introduced below. It is obvious that the accompanying drawings described below are only some embodiments of the present disclosure, and other accompanying drawings can be obtained by those of skill in the art based on these drawings without creative efforts.

FIG. 1 illustrates a diagrammatic view of a cleaning assembly of the present disclosure;

FIG. 2 illustrates an exploded view of the cleaning assembly of the present disclosure;

FIG. 3 illustrates a partially enlarged view of a part A in FIG. 2;

FIG. 4 illustrates a diagrammatic view of a pressure plate of the cleaning assembly of the present disclosure;

FIG. 5 illustrates a diagrammatic view of the pressure plate of the cleaning assembly of the present disclosure from another angle;

FIG. 6 illustrates a sectional view of the pressure plate of the cleaning assembly of the present disclosure;

FIG. 7 illustrates a sectional view of an upper cover of the cleaning assembly of the present disclosure;

FIG. 8 illustrates a diagrammatic view of a lower cover of the cleaning assembly of the present disclosure;

FIG. 9 illustrates a diagrammatic view of a nozzle cover of the cleaning assembly of the present disclosure;

FIG. 10 is a sectional view of the nozzle cover of the cleaning assembly of the present disclosure;

FIG. 11 illustrates a diagrammatic view of the cleaning assembly of the present disclosure in an initial state;

FIG. 12A illustrates a first diagrammatic view of the cleaning assembly of the present disclosure when a spray bar portion extends;

FIG. 12B illustrates a second diagrammatic view of the cleaning assembly of the present disclosure when the spray bar portion extends;

FIG. 12C illustrates a third diagrammatic view of the cleaning assembly of the present disclosure when the spray bar portion extends;

FIG. 13A illustrates a first diagrammatic view of the cleaning assembly of the present disclosure when the spray bar portion retracts;

FIG. 13B illustrates a second diagrammatic view of the cleaning assembly of the present disclosure when the spray bar portion retracts; and

FIG. 13C illustrates a third diagrammatic view of the cleaning assembly of the present disclosure when the spray bar portion retracts.

In the drawings, bracket 10; guide portion 101; guide hole 1011; avoidance groove 1012; position-limiting portion 1013; spray bar portion 20; transmission portion 201; self-cleaning assembly 30; upper cover 301; cleaning hole 3011; third installation position 3012; boss 3013; groove 3014; slot 3015; lower cover 302; through hole 3021; fixing portion 3023; pressure plate 40; actuating portion 401; driving surface 4010; first driving surface 4011; second driving surface 4012; transition portion 4013; first installation position 402; buckling hole 4021; fixing hole 4022; second installation position 403; first buckle 404; second buckle 405; fixing surface 4051; descaling piece 50; reset device 60; sealing piece 70; nozzle cover 80; nozzle 801; water passage 802; rib 803; driving motor 901; conveyor belt 902; and transition gear 903.

### DETAILED DESCRIPTION OF THE EMBODIMENTS

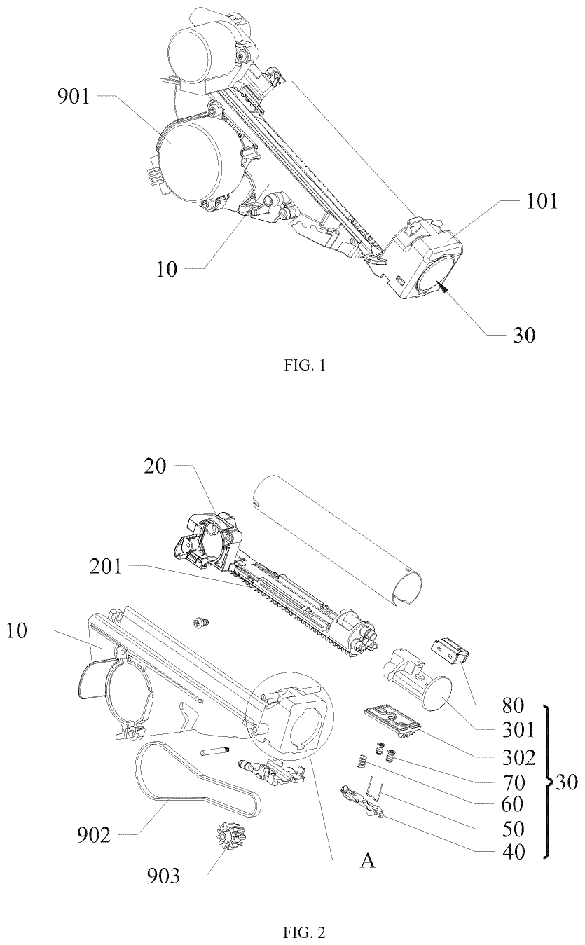

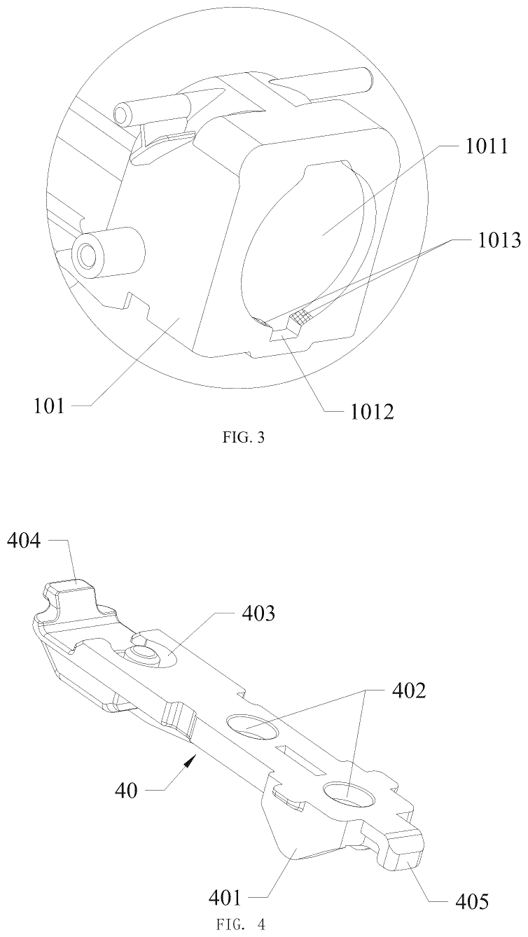

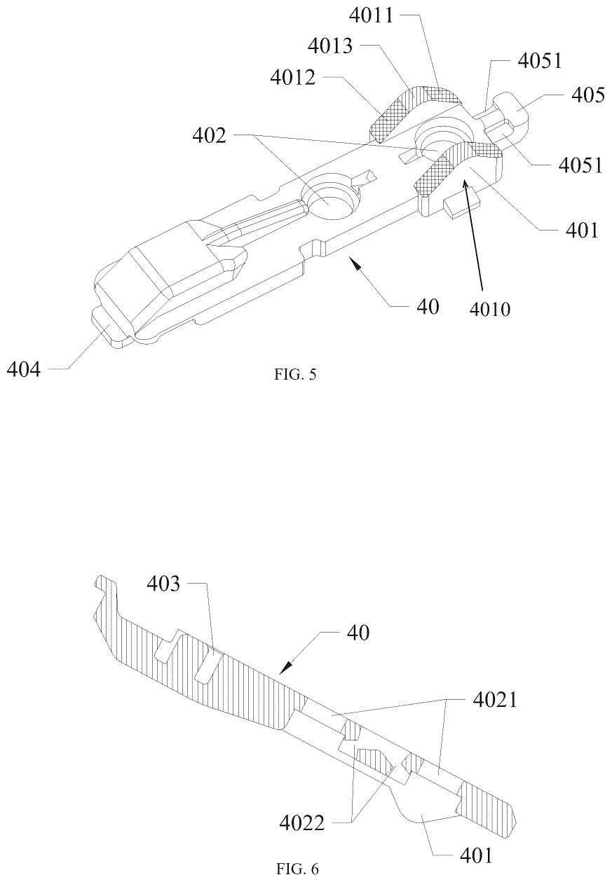

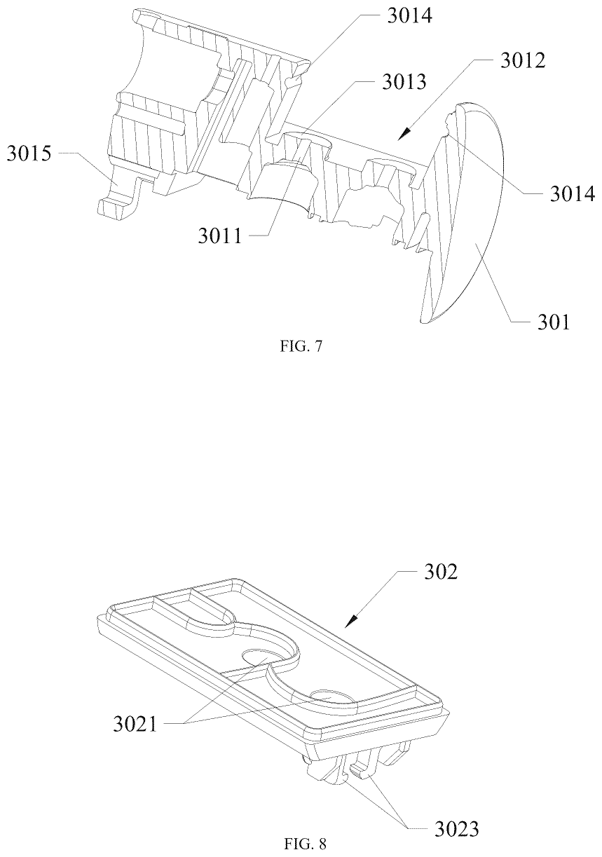

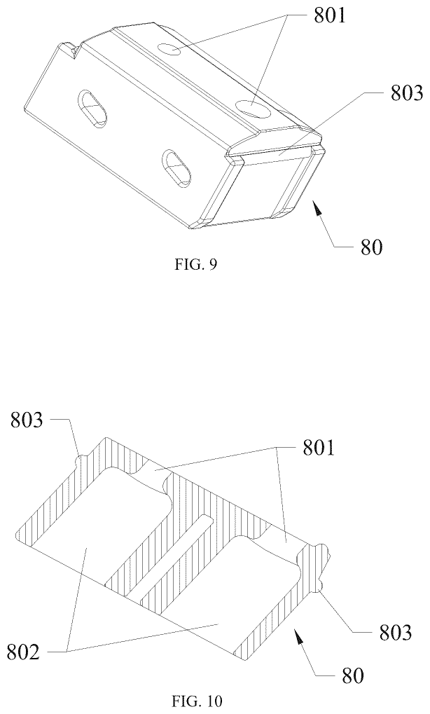

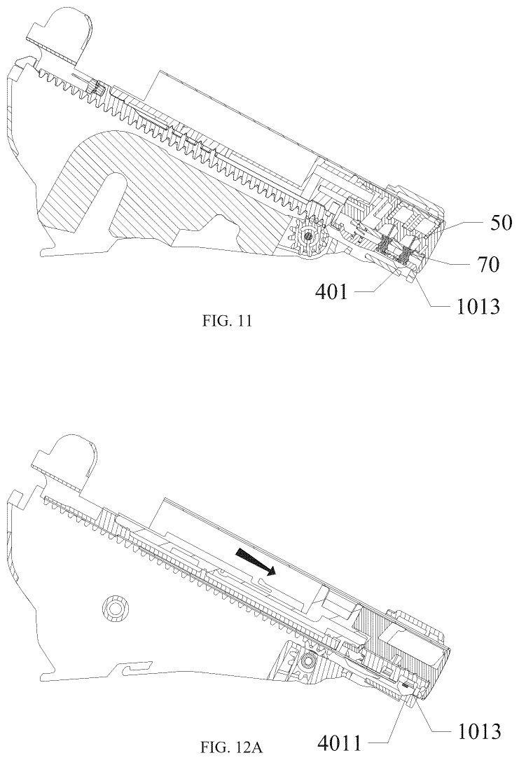

The present disclosure will be described in detail below in combination with FIGS. 1-13.

A cleaning assembly comprises a bracket 10 and a spray bar portion 20 configured to extend and retract on the bracket 10. A front end of the spray bar portion 20 is disposed with a self-cleaning assembly 30 configured to extend and retract accordingly.

The self-cleaning assembly 30 comprises an upper cover 301 and a pressure plate 40. The upper cover 301 comprises cleaning holes 3011 and a slot 3015. A first end of the pressure plate 40 is pivotally connected to an inner side of the slot 3015 and is located on an outer side of the upper cover 301. An actuating portion 401 is disposed on a second end of the pressure plate 40, and a reset device 60 is disposed between the pressure plate 40 and the upper cover 301. At least one descaling piece 50 is disposed on the pressure plate 40. A position-limiting portion 1013 configured to abut the actuating portion 401 is disposed on the bracket 10, and the position-limiting portion 1013 is located on a path along which the self-cleaning assembly 30 extends or retracts with the spray bar portion 20. When the spray bar portion 20 drives the self-cleaning assembly 30 to extend and retract, the actuating portion 401 of the pressure plate 40 abuts the position-limiting portion 1013, causing the pressure plate 40 to swing around the slot 3015 in a direction towards the upper cover 301, thus inserting the at least one descaling piece 50 into the cleaning holes 3011. When the actuating portion 401 is separated from the position-limiting portion 1013 during an extension-retraction process, and the reset device 60 pulls the at least one descaling piece 50 out of the cleaning holes 3011 completely.

Therefore, the actuating portion 401 of the pressure plate 40 respectively abuts the position-limiting portion 1013 during the extension-retraction process, so that the position-limiting portion 1013 respectively pushes the pressure plate 40 to swing in the direction towards the upper cover 301 during the extension-retraction process of the pressure plate 40, thus respectively inserting the at least one descaling piece 50 into the cleaning holes 3011 during the extension-retraction process. Therefore, the at least one descaling piece 50 can clean the cleaning holes 3011 twice in one extension-retraction cycle of the spray bar portion 20, effectively preventing scaling in the cleaning holes 3011.

In this embodiment, the pressure plate 40 is pivotally connected to a bottom of the upper cover 301 through the slot 3015, and the actuating portion 401 is disposed on a lower end surface of the pressure plate 40, so that the pressure plate 40 can abut the position-limiting portion 1013 when extending or retracting with the spray bar portion 20, thereby pushing the pressure plate 40 to enable the second end of the pressure plate 40 to swing upward around the slot 3015 in the direction towards the upper cover 301. In other embodiments, the pressure plate 40 can also be pivotally connected to a top of the upper cover 301 through the slot 3015, and the actuating portion 401 is disposed on an upper end surface of the pressure plate 40, so that the pressure plate 40 can abut the position-limiting portion 1013 when extending or retracting with the spray bar portion 20, thereby pushing the pressure plate 40 to enable the second end of the pressure plate 40 to swing downward around the slot 3015 in the direction towards the upper cover 301.

In this embodiment, front and rear sides of the actuating portion 401 comprise driving surfaces 4010 along an extension-retraction direction of the pressure plate 40, and heights of the driving surfaces 4010 are higher than that of the position-limiting portion 1013. Further, the driving surfaces 4010 comprise a first driving surface 4011 and a second driving surface 4012, and a transition portion 4013 is connected to the first driving surface 4011 and the second driving surface 4012. When the spray bar portion 20 extends, the position-limiting portion 1013 abuts and pushes the first driving surface 4011 to allow the pressure plate 40 to swing upward. When the spray bar portion 20 retracts, the position-limiting portion 1013 abuts and pushes the second driving surface 4012 to allow the pressure plate 40 to swing upward. When the transition portion 4013 abuts the position-limiting portion 1013, the pressure plate 40 swings upward to a highest point.

In this embodiment, a guide portion 101 is disposed on a front end of the bracket 10, and the guide portion 101 comprises a guide hole 1011 configured to allow the spray bar portion 20 to extend and retract. At least part of an inner wall surface of a bottom of the guide hole 1011 constitutes the position-limiting portion 1013.

In this embodiment, a transmission portion 201 configured for operatively connecting to a driving motor 901 is disposed on a bottom of the spray bar portion 20. The bottom of the guide hole 1011 comprises an avoidance groove 1012 configured for providing a space for the transmission portion 201. The position-limiting portion 1013 is disposed on two sides of the avoidance groove 1012, and the actuating portion 401 is correspondingly disposed on two sides of a bottom of a front end of the pressure plate 40, where the transmission portion 201 is a rack. Specifically, the driving motor 901 is disposed on the bracket 10, a first end of a conveyor belt 902 is sleeved on an output end of the driving motor 901, a second end of the conveyor belt 902 is sleeved on a transition gear 903, and the transition gear 903 is engaged with the transmission portion 201, so that the spray bar portion 20 extends and retracts through a forward and reverse rotation of the driving motor 901.

In this embodiment, the pressure plate 40 comprises first installation positions 402 and a second installation position 403. The first installation positions 402 are away from the first end of the pressure plate 40 pivotally connected to the slot 3015 and are used for installing the at least one descaling piece 50. The second installation position 403 is close to the first end of the pressure plate 40 pivotally connected to the slot 3015 and is used for installing the reset device 60. Further, sealing pieces 70 are buckled into the first installation positions 402, and the sealing pieces 70 are sleeved on lower portions of the at least one descaling piece 50.

In this embodiment, the at least one descaling piece 50 is descaling needles. First ends of the descaling needles have bent shapes, and second ends of the descaling needles have straight shapes. The first installation positions 402 comprise buckling holes 4021 and fixing holes 4022, and side walls of the buckling holes 4021 comprise protrusions. The descaling needles are disposed in the buckling holes 4021, and the first ends of the descaling needles that have the bent shapes are inserted into the fixing holes 4022. At the same time, the sealing pieces 70 are buckled in the buckling holes 4021 through the protrusions and are sleeved outside of the descaling needles. Specifically, the first installation positions 402 comprise two first installation positions 402, although a number of the first installation positions 402 can be increased or decreased according to actual needs. A corresponding one of the descaling needles is disposed in each of the first installation positions 402, a corresponding one of the sealing pieces 70 is sleeved outside of each of the descaling needles, and each of the sealing pieces 70 is buckled in a corresponding one of first installation positions 402. The second installation position 403 is groove-shaped and used for fixing a lower end of the reset device 60, and the reset device 60 is a spring. The reset device 60 is used to ensure that the descaling needles can return to initial positions after being inserted into the cleaning holes 3011 for dredging and cleaning.

In this embodiment, a lower end of the upper cover 301 is connected to a lower cover 302, and the lower cover 302 comprises through holes 3021 and an accommodating groove. The sealing pieces 70 slidably and hermetically cooperate with inner sides of the through holes 3021, and the accommodating groove cooperates with the second installation position 403 to fix an upper end and the lower end of the reset device 60 respectively, ensuring that a position of the reset device 60 does not dislocate during an operation process. Further, parts of the sealing pieces 70 disposed in the through holes 3021 are Y-shaped, thus reducing frictional resistance forces of the sealing pieces 70 with inner walls of the through holes 3021 during a sliding process while ensuring sealing.

In this embodiment, a front end of the lower cover 302 comprises a fixing portion 3023. The pressure plate 40 comprises a first buckle 404 and a second buckle 405 along a length direction of the pressure plate 40, respectively. The first buckle 404 is connected to the lower end of the upper cover 301, facilitating the pressure plate 40 to swing around the first buckle 404 when the actuating portion 401 is pushed by the position-limiting portion 1013. The second buckle 405 is overlapped with the fixing portion 3023, and the fixing portion 3022 is used to limit an initial position of the pressure plate 40. Further, the fixing portion 3022 comprises two buckles with opposite hooks, and the second buckle 405 comprises fixing surfaces 4051 overlapped with the opposite hooks.

In this embodiment, an upper end of the upper cover 301 comprises a third installation position 3012 for installing a nozzle cover 80, and the nozzle cover 80 comprises nozzles 801 in communication with the cleaning holes 3011. Specifically, the nozzle cover 80 comprises the nozzles 801 and water passages 802, which are in communication with each other. A bottom wall of the third installation position 3012 comprises bosses 3013, and the bosses 3013 comprise the cleaning holes 3011. The water passages 802 are sleeved outside of the bosses 3013. Front and rear side walls of the third installation position 3012 comprise a groove 3014, and front and rear side walls of the nozzle cover 80 comprise a rib 803 configured to be buckled in the groove 3014.

A working principle of the cleaning assembly disclosed in the present disclosure is as follows:

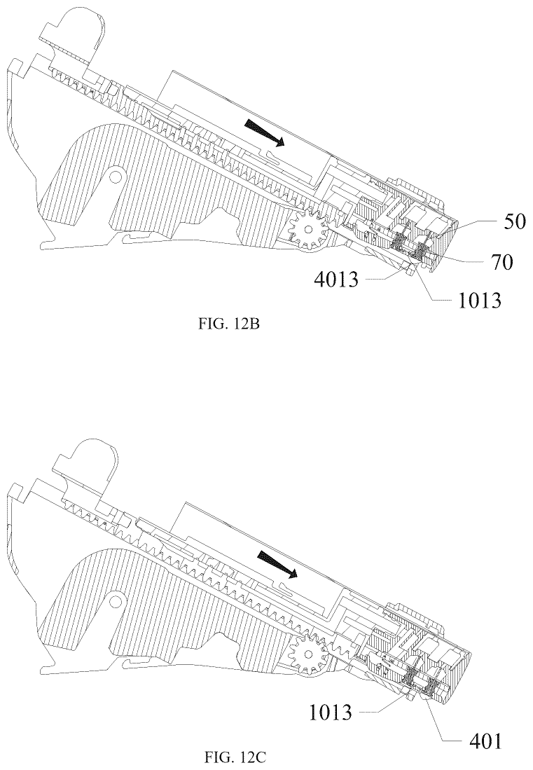

For an example, the first buckle 404 of the pressure plate 40 is pivotally connected to a lower side of the upper cover 301. The driving motor 901 starts to rotate forward to allow the spray bar portion 20 to extend forward, and the self-cleaning assembly 30 moves forward with the spray bar portion 20. The first driving surface 4011 of the actuating portion 401 abuts the position-limiting portion 1013, as shown in FIG. 12A. The self-cleaning assembly 30 continues to move forward with the spray bar portion 20, and the position-limiting portion 1013 pushes the pressure plate 40 to swing upward around the slot 3015 through the first driving surface 4011 until the transition portion 4013 abuts the position-limiting portion 1013, allowing the sealing pieces 70 disposed on the pressure plate 40 to slide upward in the through holes 3021 and the descaling needles to move upward to be inserted into the cleaning holes 3011. At this time, the pressure plate 40 swings upward to the highest point, thereby dredging and cleaning the cleaning holes 3011, as shown in FIG. 12B. The self-cleaning assembly 30 continues to move forward with the spray bar portion 20, the actuating portion 401 is separated from the position-limiting portion 1013, the pressure plate 40 swings downward to drive the sealing pieces 70 to slide downward in the through holes 3021 under an action of the reset device 60 until the second buckle 405 abuts the opposite hooks of the lower cover 302, and the descaling needles are then pulled out of the cleaning holes 3011, as shown in FIG. 12C. Thus, a primary dredging and cleaning of the cleaning holes 3011 is completed.

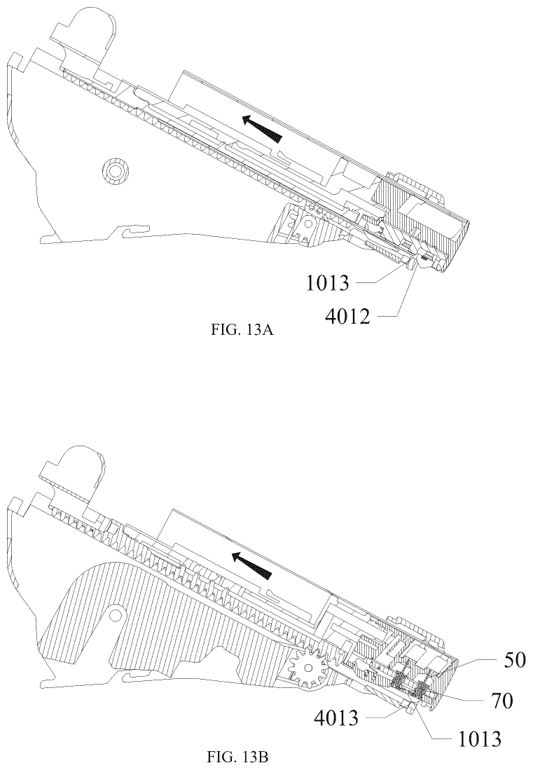

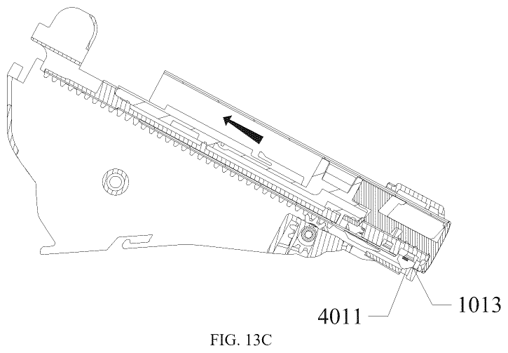

The driving motor 901 starts to rotate reverse to allow the spray bar portion 20 to retract backward, and the self-cleaning assembly 30 retracts backward with the spray bar portion 20. The second driving surface 4012 of the actuating portion 401 abuts the position-limiting portion 1013, as shown in FIG. 13A. The self-cleaning assembly 30 continues to move backward with the spray bar portion 20, and the position-limiting portion 1013 pushes the pressure plate 40 to swing upward around the slot 3015 through the second driving surface 4012 until the transition portion 4013 abuts the position-limiting portion 1013, allowing the sealing pieces 70 disposed on the pressure plate 40 to slide upward in the through holes 3021 and the descaling needles to move upward to be inserted into the cleaning holes 3011. At this time, the pressure plate 40 swings upward to the highest point, thereby dredging and cleaning the cleaning holes 3011, as shown in FIG. 13B. The self-cleaning assembly 30 continues to move backward with the spray bar portion 20, the actuating portion 401 is separated from the position-limiting portion 1013, the pressure plate 40 swings downward to drive the sealing pieces 70 to slide downward in the through holes 3021 under the action of the reset device 60 until the second buckle 405 abuts the opposite hooks of the lower cover 302, and the descaling needles are pulled out of the cleaning holes 3011, as shown in FIG. 13C. Thus, a secondary dredging and cleaning of the cleaning hole 3011 is completed.

Therefore, once a user uses the spray bar portion 20, the self-cleaning assembly 30 will be respectively inserted into the cleaning holes 3011 for dredging and cleaning during the extension-retraction process of the spray bar portion 20. That is, the cleaning holes 3011 will be dredged and cleaned twice each time the user uses the spray bar portion 20, continuously maintaining the cleaning holes 3011 in an unblocked state, and ensuring the self-cleaning function of the nozzles 801 to be normally operated. The preceding embodiments are merely provided to illustrate the technical concept and the features of the present disclosure, allowing the content of the present disclosure to be understood and implemented by those of skill in the art, and the protection scope of the present disclosure should not be limited thereto. It is intended that the protective scope of the present disclosure cover any equivalent variation or modification provided it is made in accordance with the spirit and essence of the present disclosure.

What is claimed is:

1. A cleaning assembly, comprising:
a bracket, and
a spray bar portion configured to extend and retract on the bracket, wherein:
a self-cleaning assembly configured to extend and retract with the spray bar portion is disposed on a front end of the spray bar portion,
the self-cleaning assembly comprises an upper cover and a pressure plate,
the upper cover comprises one or more cleaning holes and a slot,
a first end of the pressure plate is pivotally connected to an inner side of the slot and is located on an outer side of the upper cover,
an actuating portion is disposed on a second end of the pressure plate,
a reset device is disposed between the pressure plate and the upper cover,
one or more descaling pieces are further disposed on the pressure plate,
a position-limiting portion configured to abut the actuating portion is disposed on the bracket,
the position-limiting portion is located on a path along which the self-cleaning assembly extends and retracts with the spray bar portion,
when the spray bar portion drives the self-cleaning assembly to extend and retract, the actuating portion of the pressure plate abuts the position-limiting portion, causing the pressure plate to swing around the slot in a direction towards the upper cover, thus inserting the one or more descaling pieces into the one or more cleaning holes, and
when the spray bar portion drives the self-cleaning assembly to continuously extend and retract, the actuating portion is separated from the position-limiting portion, and the reset device pulls the one or more descaling pieces out of the one or more cleaning holes completely.

2. The cleaning assembly according to claim 1, wherein:
the pressure plate is pivotally connected to a bottom of the upper cover through the slot, and
the actuating portion is disposed on a lower end surface of the pressure plate, so that the pressure plate is configured to abut the position-limiting portion when the pressure plate extends and retracts with the spray bar portion, thereby pushing the pressure plate to enable the second end of the pressure plate to swing about the slot in the direction towards the upper cover.

3. The cleaning assembly according to claim 1, wherein:
driving surfaces are disposed on front and rear sides of the actuating portion along an extension-retraction direction of the pressure plate, and
heights of the driving surfaces are higher than that of the position-limiting portion.

4. The cleaning assembly according to claim 3, wherein:
the driving surfaces comprise a first driving surface and a second driving surface,
a transition portion is connected to the first driving surface and the second driving surface,
when the spray bar portion extends, the position-limiting portion abuts and pushes the first driving surface to allow the pressure plate to swing upward,
when the spray bar portion retracts, the position-limiting portion abuts and pushes the second driving surface to allow the pressure plate to swing upward, and
when the transition portion abuts the position-limiting portion, the pressure plate swings upward to a highest point.

5. The cleaning assembly according to claim 1, wherein:
a guide portion is disposed on a front end of the bracket,
the guide portion comprises a guide hole configured to allow the spray bar portion to extend and retract, and
at least part of an inner wall surface of a bottom of the guide hole constitutes the position-limiting portion.

6. The cleaning assembly according to claim 1, wherein:
the pressure plate comprises one or more first installation positions and a second installation position,
the one or more first installation positions are away from the first end of the pressure plate pivotally connected to the slot and are used for installing the one or more descaling pieces, and
the second installation position is adjacent to the first end of the pressure plate pivotally connected to the slot, and is used for installing the reset device.

7. The cleaning assembly according to claim 6, wherein:
one or more sealing pieces are buckled into the one or more first installation positions, and
the one or more sealing pieces are sleeved on one or more lower portions of the one or more descaling pieces.

8. The cleaning assembly according to claim 7, wherein:
a lower end of the upper cover is connected to a lower cover,
the lower cover comprises one or more through holes and an accommodating groove,
the one or more sealing pieces slidably and hermetically cooperate with one or more inner sides of the one or more through holes, and
the accommodating groove cooperates with the second installation position to fix an upper end and a lower end of the reset device respectively.

9. The cleaning assembly according to claim 8, wherein:
one or more parts of the one or more sealing pieces disposed in the one or more through holes are Y-shaped.

10. The cleaning assembly according to claim 8, wherein:
a front end of the lower cover comprises a fixing portion,
the first end of the pressure plate comprises a first buckle,
the second end of the pressure plate comprises a second buckle,
the second installation position is adjacent to the first buckle,
the actuating portion and the one or more first installation positions are adjacent to the second buckle,
the first buckle is pivotally connected to the slot, and
the second buckle is overlapped with the fixing portion.

11. The cleaning assembly according to claim 10, wherein:
the fixing portion comprises two buckles with opposite hooks, and
the second buckle comprises a fixing surface overlapped with the opposite hooks.

12. The cleaning assembly according to claim 1, wherein:
an upper end of the upper cover comprises a third installation position for installing a nozzle cover, and
the nozzle cover comprises nozzles in communication with the one or more cleaning holes.
